(19) United States
(12) Patent Application Publication
(10) Pub. No.: US 2026/0057294 A1
(43) Pub. Date: Feb. 26, 2026

(54) METHODS, SYSTEMS, ARTICLES OF MANUFACTURE AND APPARATUS TO TRAIN A MACHINE LEARNING MODEL WITH A DYNAMIC MARGIN

(71) Applicant: Nielsen Consumer LLC, Chicago, IL (US)

(72) Inventors: Diego Ortego Hernández, Alcobendas (ES); David Jiménez Cabello, Lupiana (ES)

(21) Appl. No.: 18/962,967

(22) Filed: Nov. 27, 2024

Related U.S. Application Data
(60) Provisional application No. 63/686,573, filed on Aug. 23, 2024.

(51) Int. Cl. G06N 20/00

(52) U.S. Cl. CPC G06N 20/00

(57) ABSTRACT

Systems, apparatus, articles of manufacture, and methods are disclosed to train models with a dynamic margin. An example apparatus includes interface circuitry, machine-readable instructions, and at least one processor circuit to be programmed by the machine-readable instructions to determine a positive label similarity value and a negative label similarity value, the positive and negative similarity values based on a query embedding, determine a negative-to-positive difference value and a positive-to-negative difference value associated with the positive label similarity value and the negative label similarity value, determine a positive-to-negative difference value associated with the positive label similarity value and the negative label similarity value, and cause training of a label classifier with a loss function having a dynamic margin when the positive-to-negative difference value satisfies a threshold.

### RELATED APPLICATION

This patent claims the benefit of U.S. Provisional Patent Application No. 63/686,573, which was filed on Aug. 23, 2024. U.S. Provisional Patent Application No. 63/686,573 is hereby incorporated herein by reference in its entirety. Priority to U.S. Provisional Patent Application No. 63/686,573 is hereby claimed.

### FIELD OF THE DISCLOSURE

This disclosure relates generally to training accuracy and, more particularly, to methods, systems, articles of manufacture and apparatus to train a machine learning model with a dynamic margin.

### BACKGROUND

The field of machine learning has experienced significant growth in recent years, with applications ranging from image recognition to natural language processing. As a result, there has been an increasing demand for efficient and accurate models that can perform well on various tasks. However, the performance capabilities of these models during inference (i.e., after training) are often limited by their initial training efforts. The quality of the model's performance is heavily dependent on the quantity and diversity of the data used to train it. In other words, a robustly trained model that has been exposed to a large and representative dataset with accurate labels can achieve superior performance during inference. In contrast, models that are not adequately trained may struggle to generalize well or make accurate predictions in real-world scenarios.

### BRIEF DESCRIPTION OF THE DRAWINGS

FIG. 1 is a block diagram of an example environment in which example model trainer circuitry operates to train a model with a dynamic margin.

FIG. 2A is a block diagram of an example implementation of the model trainer circuitry of FIG. 1.

FIG. 2B is a data table of example triplet loss results in view of example values of negative similarity values and positive similarity values.

FIGS. 3-5 are flowcharts representative of example machine-readable instructions and/or example operations that may be executed, instantiated, and/or performed by example programmable circuitry to implement the model trainer circuitry of FIG. 2A.

FIG. 6 is a block diagram of an example processing platform including programmable circuitry structured to execute, instantiate, and/or perform the example machine-readable instructions and/or perform the example operations of FIGS. 3-5 to implement the model trainer circuitry of FIG. 2A.

FIG. 7 is a block diagram of an example implementation of the programmable circuitry of FIG. 6.

FIG. 8 is a block diagram of another example implementation of the programmable circuitry of FIG. 6.

FIG. 9 is a block diagram of an example software/firmware/instructions distribution platform (e.g., one or more servers) to distribute software, instructions, and/or firmware (e.g., corresponding to the example machine-readable instructions of FIGS. 3-5) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

In various applications, recommendation systems generate a set of potential candidate objects that exhibit similar characteristics to a query object. For instance, in an e-commerce setting, recommendation systems may suggest products based on previously purchased items or books recommended by users with similar reading habits. Similarly, in search engines, candidates are generated for sponsored searches based on user behavior and preferences. Generation of a recommendation may be performed in response to an input description of a query object, such as a query product (e.g., when recommendation system operates in a retail environment). In some environments, recommendation systems return candidate movies based on previously watched movies, candidate books based on previously read books, or candidate vacation destinations based on previously travelled destinations. In any environment, recommendation systems permit the generation of a set of potential candidate objects that exhibit similar characteristics to the query object (e.g., the query movie, the query book, the query product, etc.).

In some circumstances one or more models are used to compare the object to one or more candidate objects in an effort to identify suitable matches. For example, a query product having a set of characteristics may be similar to a candidate product having similar characteristics. In some circumstances, suitable matches are influenced by frequency characteristics, such as candidate products that are purchased with a similar cadence and/or purchased together with the query product. Extreme Multi-label Classification (XMC) models may be used to predict the most relevant subset of objects for a given query data point. XMC models may be used for product recommendation in e-commerce, document tagging and/or sponsored searches, etc. XMC models learn one or more encoders and/or classifiers based on sourced training data in the form of text, images, graphs, etc.

The training process involves cultivating and transforming the sourced data into a vector space, where each object is represented as an embedding with associated positive or negative labels. As used herein, positive labels represent label embeddings that are similar to a query embedding (e.g., an embedding associated with an object with which the model is to be trained). As used herein, negative labels represent label embeddings that are different than the query embedding to permit model training that distinguishes a suitable candidate object from a non-matching candidate object. Generally speaking, model inference accuracy depends on robust model training that employs matching objects and non-matching (dissimilar) objects.

Known XMC models leverage a loss function based on queries and different types of labels (e.g., positive labels and negative labels). Loss functions of the known XMC models employ a static margin to permit training refinement when metrics associated with the positive labels and the negative labels are similar. However, this approach can lead to diminished model accuracy when training data samples have similar or dissimilar similarity metrics, as it results in reduced differentiation between matching and non-matching objects. As used herein, a static margin refers to a fixed value used in the loss function to differentiate between positive and negative labels. Consider an example in which two objects are attempting to be distinguished one that is similar to a query object (positive label), and another object that is dissimilar (negative label). The static margin is a distance metric that determines how far apart these two embeddings need to be for the model to correctly classify them.

In traditional XMC models, the loss function often employs a fixed margin between positive and negative labels. This means that if the similarity metric between the query object's embedding and a candidate object's embedding is above this threshold (i.e., closer than the static margin), the object is considered (e.g., labeled) as a positive match: otherwise, it is considered a non-match.

In the event a positive embedding is associated with a similarity metric that is substantially different than a similarity metric of a negative embedding, the same static margin is used to determine a loss value for training purposes. Further, in the event a positive embedding is associated with a similarity metric that is close to a similarity metric of a negative embedding, the same static margin is used to determine a loss value for training purposes. Because the loss value is directly related to the ability of a model to accurately predict an outcome(s), similar loss values for dissimilar training input during a model training phase diminishes an ability for the model to perform accurately during inference. When inaccurate predictions occur during inference, such inaccurate data samples are stored in one or more memory locations (e.g., databases, memory circuits, etc.) and transmitted over one or more networks for further analysis and/or data cleansing operation(s). Stated differently, a quality of model training has a direct impact on model inference performance and a volume of data transmitted on one or more networks. Examples disclosed herein employ XMC models with a Label Prototype Network (LPN) that learns to aggregate text-based embeddings, label centroids, and learnable free vectors while optimizing the model with a dynamic margin loss to improve model training and inference accuracy.

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, and as described above, the model may be trained with data (e.g., label embeddings) to recognize patterns and/or associations and follow such patterns and/or associations when processing input data such that other input(s) result in output(s) consistent with the recognized patterns and/or associations.

Many different types of machine learning models and/or machine learning architectures exist. In examples disclosed herein, an XMC model is used. Using an XMC model enables training consideration with a triplet loss based on a query, a positive label, and a negative label. In general, machine learning models/architectures that are suitable to use in the example approaches disclosed herein will be models that employ a loss function with an aggregation model, such as an LPN to aggregate text-based embeddings, label centroids, and learnable free vectors. However, other types of machine learning models could additionally or alternatively be used.

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.) Alternatively, unsupervised training (e.g., used in deep learning, a subset of machine learning, etc.) involves inferring patterns from inputs to select parameters for the ML/AI model (e.g., without the benefit of expected (e.g., labeled) outputs).

In examples disclosed herein, ML/AI models are trained using supervised training. However, any other training algorithm may additionally or alternatively be used. In examples disclosed herein, training is performed until one or more convergence metrics is satisfied and/or epoch executions. Training is performed using hyperparameters that control how the learning is performed (e.g., a learning rate, a number of layers to be used in the machine learning model, etc.). In some examples re-training may be performed. Such re-training may be performed in response to audit metrics indicative of one or more accuracy thresholds.

Training is performed using training data. In examples disclosed herein, the training data originates from product data repositories that include sales metrics and/or product characteristics attributes. Because supervised training is used, the training data is labeled. Labeling is applied to the training data by distinguishing positive labels from negative labels.

Once training is complete, the model is deployed for use as an executable construct that processes an input and provides an output based on the network of nodes and connections defined in the model. The model is stored at one or more networked storage devices. The model may then be executed by a computing device in which results are rendered (e.g., via a web-interface for networked/remote users).

Once trained, the deployed model may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model may be captured and provided as feedback. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model.

While training data is labeled as a positive embedding (e.g., a positively labeled embedding) to represent objects similar to a query object, and labeled as a negative embedding (e.g., a negatively labeled embedding) to represent objects different (non-matching) to the query object, the binary representation of the labeled training data does not always accurately represent different degrees of similarity or dissimilarity. Stated differently, while the training data includes a binary designation as a positive or negative label for an embedding, the objects with such designations may have varying degrees of difference. If such varying degrees of difference are not considered during the model training process, then the inference accuracy of the model suffers.

For example, consider a query embedding associated with a cola flavored carbonated beverage by a first manufacturer, a positive embedding associated with a cola flavored carbonated beverage by a second manufacturer, and a negative embedding associated with a non-cola flavored non-carbonated sports drink beverage by a third manufacturer. During training of the model, the loss function causes reinforcement of similarity between the query embedding and the positive embedding due to several similar characteristics therebetween. Also, the loss function causes reinforcement of differences between the query embedding and the negative embedding because the beverage types are different, the flavor is different, and the manufacturer is different. As used herein, the example negative embedding is referred to as an “easy negative” because there are no artifacts of similarity between the query embedding and the negative embedding (other than the fact that both are beverages). Accordingly, the negative embedding contributes to the training of the model by reinforcing its ability to identify dissimilar objects (e.g., dissimilar products).

Alternatively, consider the same query embedding associated with the cola flavored carbonated beverage by the first manufacturer, the same positive embedding associated with the cola flavored carbonated beverage by the second manufacturer, and a negative embedding associated with a cola flavored carbonated beverage by the third manufacturer. In this example triad of embeddings, the negative embedding has several similar characteristics to the query embedding, thus it is difficult to determine that the embedding is negative. As used herein, the example negative embedding is referred to as a “hard negative” because of the difficulty in determining that the object associated therewith is negative. The hard negative has some similarities with the query embedding and the positive embedding, which may result in confusion that the negative embedding is a positive (which would be inaccurate). Additionally, and as described in further detail below, examples disclosed herein calculate distance and/or similarity metrics between each query embedding, positive embedding, and negative embedding. Such similarity metrics are further used in loss functions for model training in a manner consistent with example Equation 1.

$${L}_{T} = {\sum }_{i = 1}^{B} {\sum }_{\begin{matrix}j ϵ {P}_{i} \\ k ∈ {N}_{i}\end{matrix}} ( {h}_{q}^{i} \cdot {h}_{n}^{k} - {h}_{q}^{i} \cdot {h}_{p}^{j} + m ) . \qquad Equation 1$$

In the illustrated example of Equation 1, L_{T} represents a triplet loss (loss function), B represents a number of queries in a batch, q represents a query, Pᵢ represents a positive label set, Nᵢ represents a negative label set, h_{q} represents a query embedding (e.g., a sentence embedding associated with a query object), hₙ represents a negative embedding (e.g., a sentence embedding associated with a dissimilar object), hₚ represents a positive embedding (e.g., a sentence embedding associated with a similar object), and m represents a margin. The margin (m) of example Equation 1 is fixed and/or otherwise static.

In operation, the dot product of h_{q} and hₙ denote the query negative cosine similarity, which may be referred to as s_{qn}. Similarly, the dot product of h_{q} and hₚ denote the query positive cosine similarity, which may be referred to as s_{qp}. The triplet loss of example Equation 1 determines and/or otherwise calculates a difference between the positive embedding cosine similarity (s_{qp}) and the negative embedding cosine similarity (s_{qn}). When a positive embedding is substantially different from a negative embedding (e.g., when comparing a query embedding of cola to a positive embedding of cola and a negative embedding of cookies, which is a completely different product), the illustrated example of Equation 1 generates a relatively large gap value. However, if the negative embedding cosine similarity is relatively close to the positive embedding cosine similarity, then the gap generated by the illustrated example of Equation 1 is relatively small. As used herein, a relative “hardness” or “difficulty” of positive and negative magnitudes with respect to a query represent an ability to quantify a label as either similar (e.g., a match) or dissimilar (e.g., a mismatch) to the query (e.g., a query item). In particular, the reduced numeric gap of Equation 1 results in training difficulty due to not considering a relative hardness of labels. Accordingly, the known triplet loss of example Equation 1 imposes the fixed margin (m) during training such that all negatives are pushed apart from the query, while positives are pulled close.

However, while the fixed margin (m) of the triplet loss function helps to generate a gap (a difference value) when negative embedding similarity values are numerically close to positive embedding similarity values, such fixed margin values fail to consider relative hardness of the negative embeddings. Example Equation 2 illustrates a simplified version of example Equation 1.

$${L}_{T} = max ( {s}_{q n} - {s}_{q p} + m , 0 ) = \{ \begin{matrix}Δ {s}_{q}^{n - p} + m , & if Δ {s}_{q}^{p - n} \leq m \\ 0 , & otherwi s e\end{matrix} . \qquad Equation 2$$

In the illustrated example of Equation 2, s_{qn} represents the dot product of h_{q} and hₙ, which represents the cosine similarity value for the negative label. Similarly, s_{qp} represents the dot product of h_{q} and hₚ, which represents the cosine similarity value for the positive label. Additionally,

$$Δ {s}_{q}^{n - p}$$

represents the difference value after subtracting the cosine similarity value for the positive label from the cosine similarity value for the negative label (s_{qn}-s_{qp}), and

$$Δ {s}_{q}^{p - n}$$

represents the difference value after subtracting the cosine similarity value for the negative label from the cosine similarity value for the positive label (s_{qp}-s_{qn}). The margin (m) of Equation 1 and Equation 2 is static, and may be determined in an empirical manner to cause negative labels to be distanced and/or otherwise pushed apart from the query (sometimes referred to as an “anchor”). However, regardless of the margin value selected, the traditional loss function behavior of example Equation 1 and Equation 2 has no mechanism for customization when a degree of similarity between the negative label or the positive label change. As such, opportunities to determine a more accurate loss value for model training are absent from traditional approaches shown by Equation 1 and Equation 2.

As such, model training accuracy is hindered and/or accuracy improvement is suppressed. Examples disclosed herein dynamically adjust the margin in a manner that considers the relative hardness of the embeddings, thereby promoting improved model training accuracy.

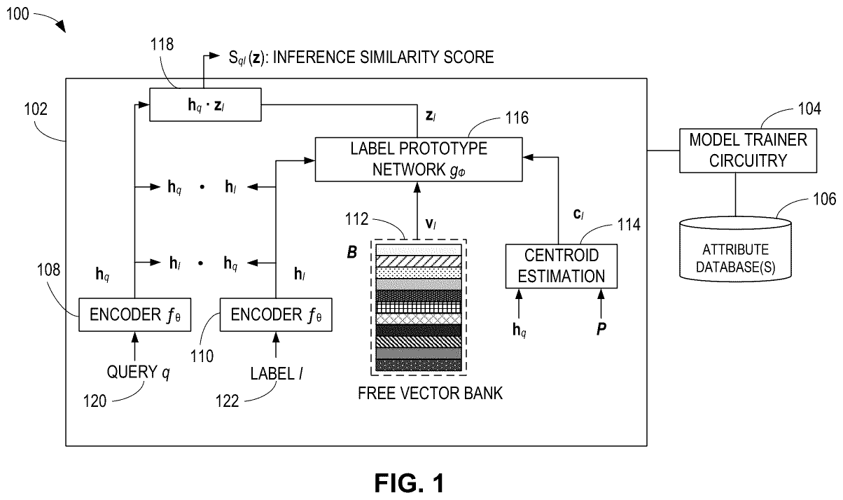

FIG. 1 is a block diagram of an example environment 100 to train with a dynamic margin. The illustrated example of FIG. 1 includes an example similarity model 102, example model trainer circuitry 104, and an example attribute database 106. The example similarity model 102 includes query encoder circuitry 108, label encoder circuitry 110, a free vector bank 112, centroid estimation circuitry 114, and an example Label Prototype Network (LPN) 116.

In operation, and after training, the LPN 116 generates an output similarity value 118 between a query 120 and a label 122. The example query encoder circuitry 108 and the example label encoder circuitry 110 learn respective functions (f_{θ}) to accurately predict a subset of positive labels given a query (q), where θ denotes parameters of a model (e.g., a neural network model). The query encoder circuitry 108 and the label encoder circuitry 110 encodes given textual representations into d-dimensional sentence embeddings used to encode respective queries (q) and labels (l) into sentence embeddings h_{q} and hᵢ, respectively. As used herein, hᵢ is further defined as hₙ and hₚ to distinguish between negative and positive text-based label embeddings, respectively. Traditional approaches to training the example similarity model implement example Equation 1 using the static margin (m). To improve model accuracy, the example model trainer circuitry 104 trains the similarity model 102 using a dynamic margin and, in some examples, attributes from the attribute database 106, as described in further detail below.

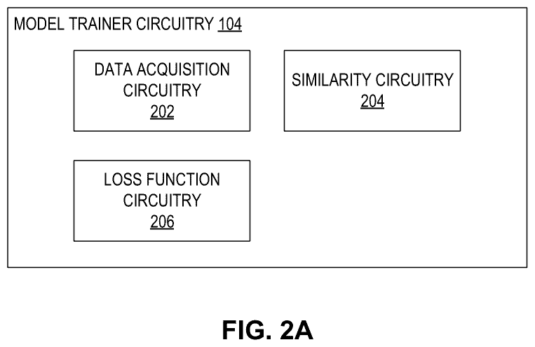

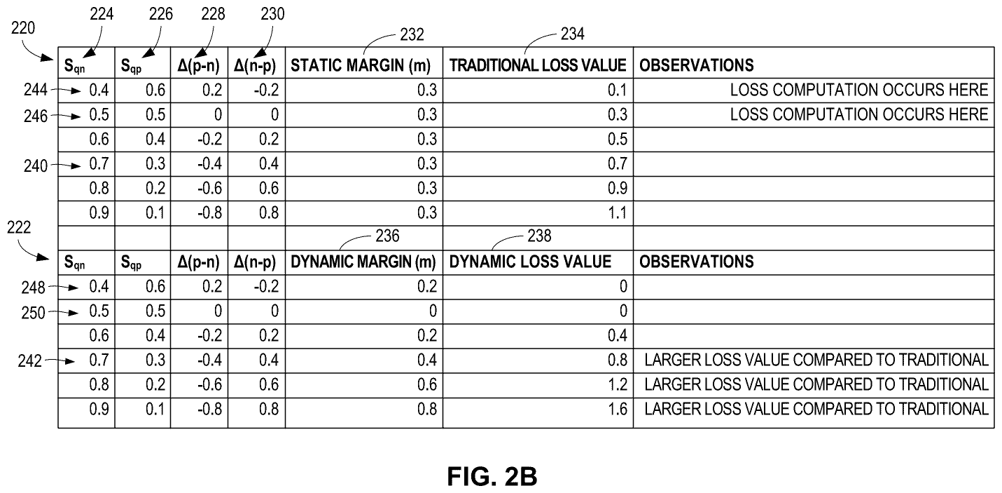

FIG. 2A is a block diagram of an example implementation of the model trainer circuitry 104 of FIG. 1 to do model training with a dynamic margin. The model trainer circuitry 104 of FIG. 2A may be instantiated (e.g., creating an instance of, bring into being for any length of time, materialize, implement, etc.) by programmable circuitry such as a Central Processor Unit (CPU) executing first instructions. Additionally or alternatively, the model trainer circuitry 104 of FIG. 2A may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2A may, thus, be instantiated at the same or different times. Some or all of the circuitry of FIG. 2A may be instantiated, for example, in one or more threads executing concurrently on hardware and/or in series on hardware. Moreover, in some examples, some or all of the circuitry of FIG. 2A may be implemented by microprocessor circuitry executing instructions and/or FPGA circuitry performing operations to implement one or more virtual machines and/or containers.

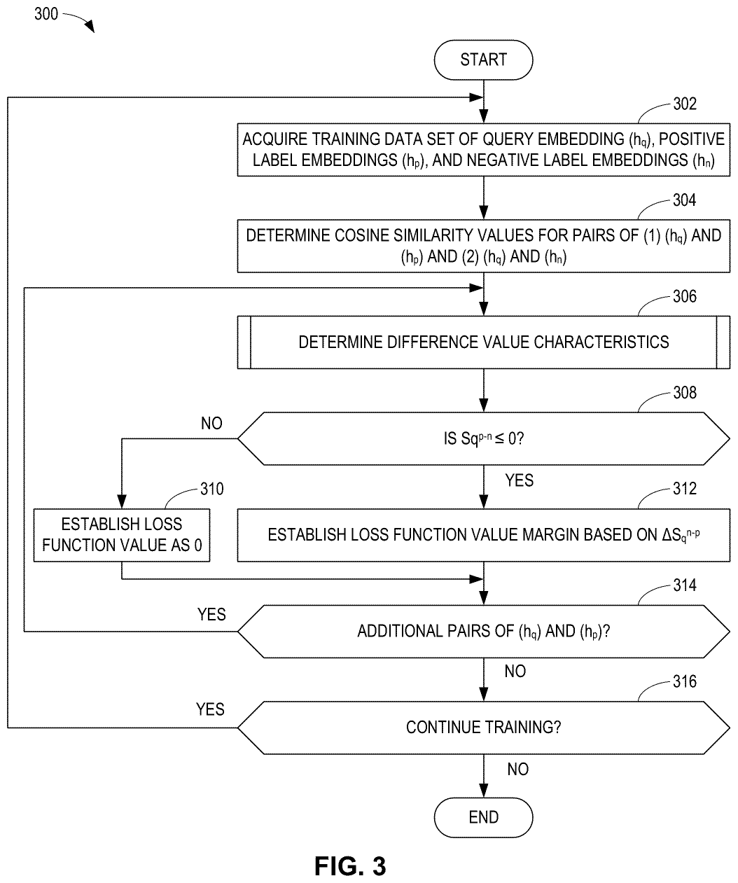

In some examples, the model trainer circuitry 104 is instantiated by programmable circuitry executing model training instructions and/or configured to perform operations such as those represented by the flowcharts of FIGS. 3-5. In some examples, the data acquisition circuitry 202 is instantiated by programmable circuitry executing data acquisition instructions and/or configured to perform operations such as those represented by the flowcharts of FIGS. 3-5. In some examples, the similarity circuitry 204 is instantiated by programmable circuitry executing similarity determination instructions and/or configured to perform operations such as those represented by the flowcharts of FIGS. 3-5. In some examples, the loss function circuitry 206 is instantiated by programmable circuitry executing loss function determination instructions and/or configured to perform operations such as those represented by the flowcharts of FIGS. 3-5.

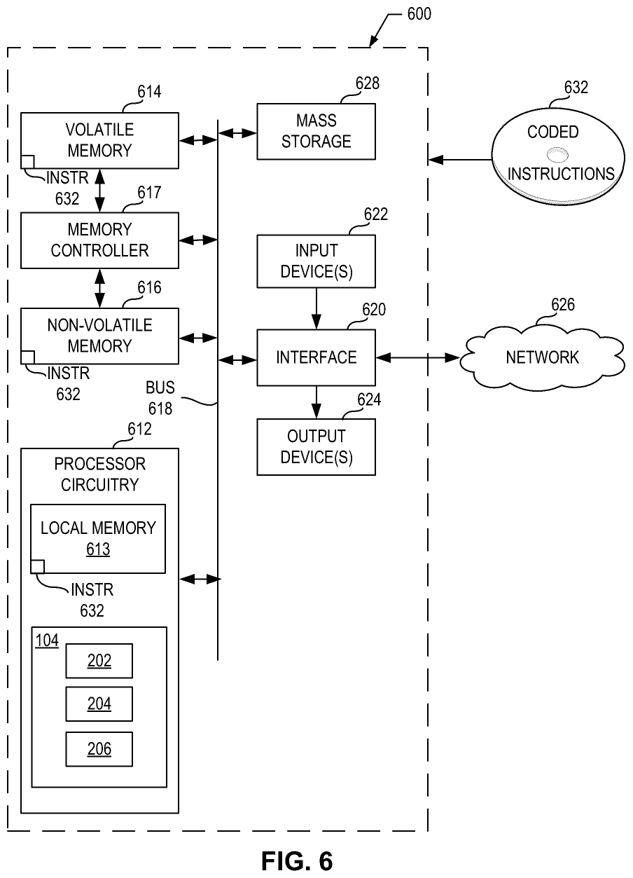

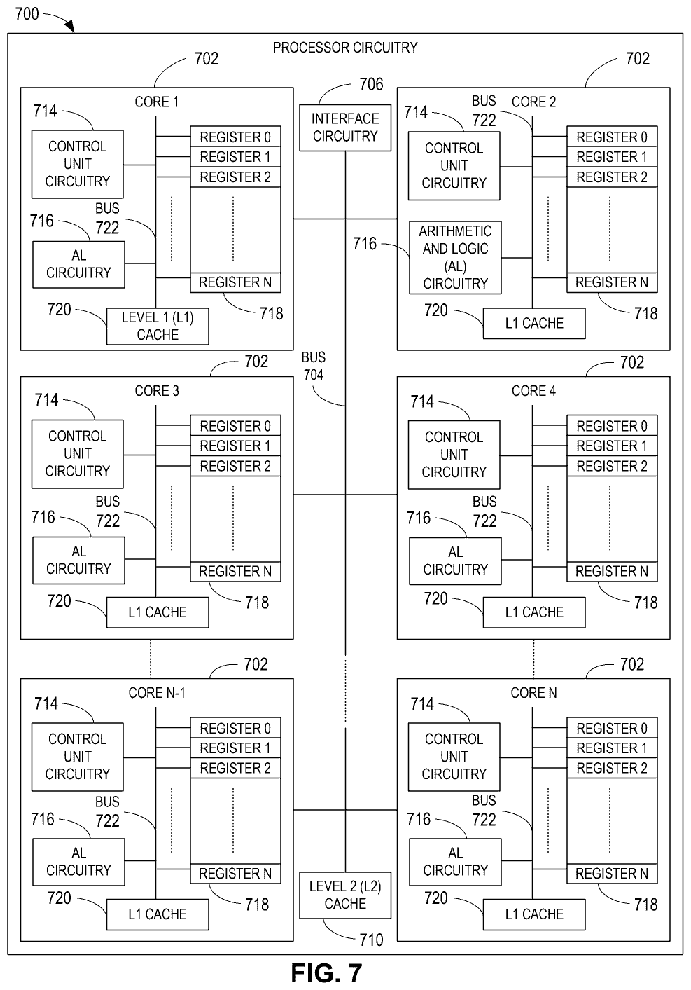

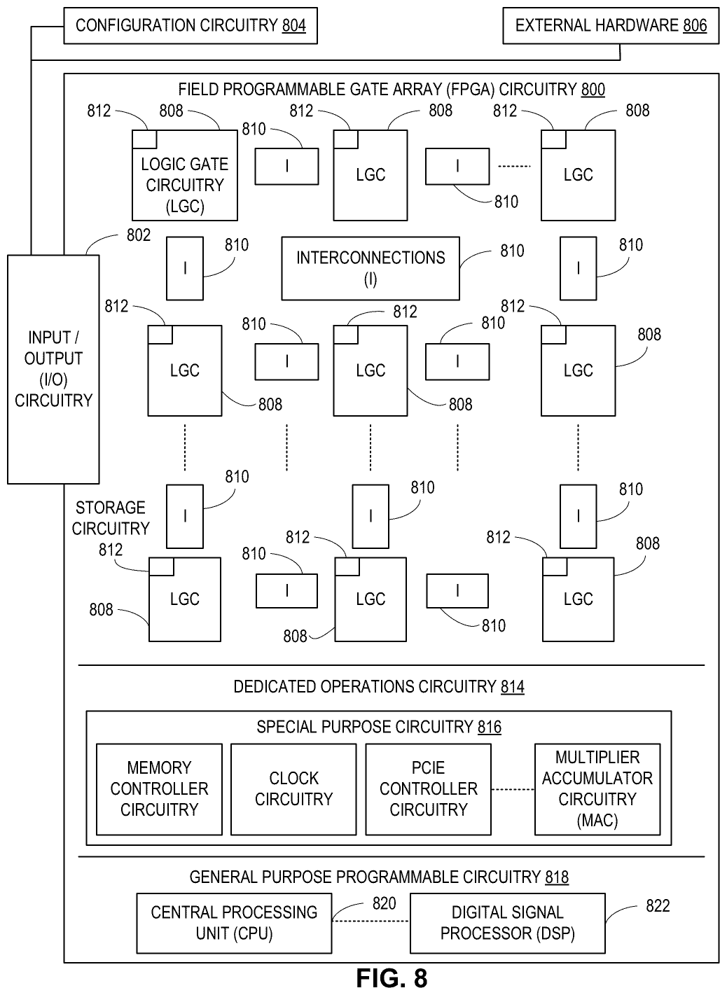

In some examples, the model trainer circuitry 104 includes means for training a model. For example, the means for model training may be implemented by model trainer circuitry 104. In some examples, the model trainer circuitry 104 includes means for data acquisition. For example, the means for data acquisition may be implemented by data acquisition circuitry 202. In some examples, the model trainer circuitry 104 includes means for similarity determination. For example, the means for similarity determination may be implemented by similarity circuitry 204. In some examples, the model trainer circuitry 104 includes means for loss function determination. For example, the means for loss function determination may be implemented by loss function circuitry 206. In some examples, the aforementioned circuitry may be instantiated by programmable circuitry such as the example programmable circuitry 612 of FIG. 6. For instance, the aforementioned circuitry may be instantiated by the example microprocessor 700 of FIG. 7 executing machine executable instructions such as those implemented by at least blocks of FIGS. 3-5. In some examples, the aforementioned circuitry may be instantiated by hardware logic circuitry, which may be implemented by an ASIC, XPU, or the FPGA circuitry 800 of FIG. 8 configured and/or structured to perform operations corresponding to the machine-readable instructions. Additionally or alternatively, the aforementioned circuitry may be instantiated by any other combination of hardware, software, and/or firmware. For example, the aforementioned circuitry may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

FIG. 2A includes additional detail of the model trainer circuitry 104 of FIG. 1. In the illustrated example of FIG. 2A, the model trainer circuitry 104 includes example data acquisition circuitry 202, example similarity circuitry 204, and example loss function circuitry 206. In operation, the data acquisition circuitry 202 acquires training data that includes query embeddings (h_{q}), positive label embeddings (hₚ), and negative label embeddings (hₙ). The example similarity circuitry 204 determines similarity values (e.g., cosine similarity values) for pairs of the acquired embeddings. In particular, the similarity circuitry 204 determines a similarity value for (a) a query embedding (h_{q}) and a positive embedding (hₚ), and (b) the query embedding (h_{q}) and a negative embedding (hₙ). Similarity values are determined for any number of available triplets of query embeddings, negative embeddings, and positive embeddings.

The similarity circuitry 204 selects a pair of embeddings to determine difference value characteristics. For example, the similarity circuitry 204 selects a negative cosine similarity value (s_{qn}) and a positive cosine similarity value (s_{qp}). The similarity circuitry 204 determines a negative-to-positive difference value

$$( Δ {s}_{q}^{n - p} )$$

in a manner consistent with example Equation 3, and determines a positive-to-negative difference value

$$( Δ {s}_{q}^{p - n} )$$

in a manner consistent with example Equation 4.

$$Δ {s}_{q}^{n - p} = {s}_{q n} - {s}_{q p} . \qquad Equation 3$$

$$Δ {s}_{q}^{p - n} = {s}_{q p} - {s}_{q n} . \qquad Equation 4$$

In the illustrated example of Equation 3, if the negative-to-positive difference value is less than zero, then the similarity value for the negative label is smaller than the similarity value for the positive label. In practice, this is consistent with expected positive and negative labels when training the model. The larger the gap between the negative label and the positive label means that the model may be trained with greater certainty when distinguishing objects more or less similar to the query object. However, in the illustrated example of Equation 4, if the positive-to-negative difference value is less than zero, then the similarity value for the negative label is greater than the similarity value for the positive label. This circumstance may occur when a hard negative exists, in which it is difficult to ascertain that the negative label is an improper match with a corresponding query label. While the margin (m) helps to create a gap between the positive label and the negative label, thereby reducing ambiguity, traditional approaches pay no regard to how small or large the gap is.

The example similarity circuitry 204 determines whether the positive-to-negative difference value of example Equation 4 is less than or equal to zero and, if so, determines a dynamic margin based on a magnitude of the gap between the positive and negative label. In particular, the loss function circuitry 206 determines, calculates and/or otherwise establishes the loss value with a margin based on example Equation 3. However, if the similarity circuitry 204 determines that the positive-to-negative difference value of example Equation 4 is not less than or equal to zero, the loss function circuitry 206 establishes, calculates and/or otherwise determines the loss value as zero. Stated differently, the loss function circuitry 206 determines the margin value in a manner consistent with example Equation 5.

$$m ( {s}_{qp} , {s}_{qn} ) = \{ \begin{matrix}{s}_{qp} - {s}_{qn} , if {s}_{qp} > {s}_{qn} \\ {s}_{qp} - {s}_{qn} , if {s}_{qp} \leq {s}_{qn}\end{matrix} . \qquad Equation 5$$

Applying example Equation 5 to example Equation 2, the loss function circuitry 206 determines the triplet loss in a manner consistent with example Equation 6.

$${L}_{T} = \{ \begin{matrix}{s}_{qp} - {s}_{qn} + ( {s}_{qp} - {s}_{qn} ) , if Δ {s}_{q}^{p - n} \\ 0 , otherwise\end{matrix} . \qquad Equation 6$$

FIG. 2B is a data table illustrating example triplet loss results in view of example values of negative cosine similarity values (s_{qn}) and positive cosine similarity values (s_{qp}) for the traditional triplet loss techniques having a static margin (m) 220 and example dynamic triplet loss techniques having a dynamic margin (m) 222. In the illustrated example of FIG. 2B, the traditional triplet loss technique 220 and the example dynamic triplet loss technique 222 include example negative cosine similarity values (s_{qn}) 224, positive cosine similarity values (s_{qp}) 226, a positive-to-negative difference value

$$( Δ {s}_{q}^{p - n} )$$

228, and a negative-to-positive difference value

$$( Δ {s}_{q}^{n - p} )$$

230. The traditional triplet loss technique 220 includes a static margin (m) 232 having an example value of 0.3. As described above, the static margin 232 may be set empirically based on any number of observations and tests to generate results that attempt to increase a gap between negative labels and positive labels when such similarity metrics might be numerically close, which may lead to inaccuracies when calculating loss values. The traditional triplet loss technique 220 also includes a loss value 234 calculated in a manner consistent with example Equation 2, in which a static margin (m) is used.

In the illustrated example of FIG. 2B, the dynamic triplet loss technique 222 includes a dynamic margin (m) 236, which establishes, determines and/or otherwise calculates the margin in a manner consistent with example Equation 5. The example loss function circuitry 206 determines and/or otherwise calculates a dynamic loss value 238 in a manner consistent with example Equation 6. In operation, examples disclosed herein to calculate and/or otherwise determine triplet loss with a dynamic margin improves loss calculation results because, in part, loss values are based on a magnitude of the gap between positive and negative labels. For instance, the example traditional triplet loss technique 220 includes a first row 240 in which the loss is determined to be 0.7 based on a static margin (m) 232 value of 0.3 and a relative gap of 0.4. However, the example dynamic triplet loss technique 222 includes a second row 242 having the same relative gap of 0.4, but determines a dynamic margin (m) 236 in a manner that depends on the magnitude of that gap, which results in a relatively larger loss value of 0.8 that is commensurate with the gap magnitude.

Additionally, examples disclosed herein to determine triplet loss with a dynamic margin result in relatively fewer loss computations compared to traditional techniques to determine triplet loss. For example, a third row 244 and a fourth row 246 of the traditional triplet loss technique 220 illustrate a loss calculation for particular positive and negative cosine similarity values. On the other hand, a fifth row 248 and a sixth row 250 of the example dynamic triplet loss technique 222 illustrate no need to perform a loss calculation for the same input values of positive and negative cosine. As such, examples disclosed herein improve an operating efficiency of computational resources dedicated to determining triplet loss by, in part, reducing a size or quantity of non-zero data elements to be transmitted over one or more networks when reporting loss values.

While examples above disclose loss calculations that employ a dynamic margin based on relative gap magnitude values between positive labels and negative labels, some examples disclosed herein determine a dynamic margin based on attributes associated with the positive labels and the negative labels. Attributes include, but are not limited to a product category, a product super-category, a product brand, a product package size, a product weight, a product volume, a product color, etc. As described above, at least one objective when minimizing a triplet loss based on a triplet (e.g., a query, a positive label, and a negative label) is to establish a similarity between the query (sometimes referred to as the “anchor”) and the positive label to have a relatively higher value than a similarity between the query and the negative label. Traditional approaches attempt to establish the positive label similarity (e.g., to the query) to be greater than the negative label similarity (e.g., to the query) by a margin (m). The triplet loss imposes that similarities with positives and negatives should not be “too close,” (e.g., the gap should not be “too close”) in which the quantification of the “too close” gap is established by the margin (m).

However, when the margin (m) is set to a fixed (static) value, a relative “hardness” or “difficulty” of the positive and negative magnitudes with respect to the query is of no consequence in the loss calculation. As described above, a “hard negative” represents a negative label in which the similarity to the query is high, and that similarity is also similar to the positive label. For example, a negative label having a similarity metric value of 0.6 and a positive label similarity metric value of 0.5 or 0.7. In view of these example conditions, it is useful to use a low margin value to relax the gap imposed between positive and negative similarities, which cannot be reliably performed with a static margin.

Examples disclosed herein utilize attributes corresponding to the positive and negative labels to establish, determine and/or otherwise calculate a margin (m). The example data acquisition circuitry 202 acquires a data set of query embeddings, positive label embeddings, and negative label embeddings for purposes of training a model. The model trainer circuitry 104 selects a pair of embeddings having a query embedding with query attribute values (Q^{α}) and a label embedding with label attribute values (L^{α}). The label attribute values (L^{α}) are associated with either the positive embedding or the negative embedding for each selected pair. Because each label embedding and query embedding can have any number of particular attributes, the model trainer circuitry 104 selects a subset of attributes for analysis. The example similarity circuitry 204 determines a cardinality of intersecting ones of the query attribute values (Q^{α}) and label attribute values (L^{α}) in a manner consistent with example Equation 7.

$$card ( Q A ) = card ( {Q}^{a} ⋂ {L}^{a} ) . \qquad Equation 7$$

In the illustrated example of Equation 7, Q^{α} and L^{α} are, respectively, the set of attribute values for query q and label l, while card(·) is a cardinality function for any set. The example similarity circuitry 204 determines a distance metric

$$( {d}_{l}^{a} )$$

for the pair in a manner consistent with example Equation 8, for which Equation 7 is shown as the numerator.

$${d}_{l}^{a} = 1 - \frac{card ( {Q}^{a} ⋂ {L}^{a} )}{card ( {Q}^{a} )} . \qquad Equation 8$$

In the illustrated example of Equation 8, the distance metric

$$( {d}_{l}^{a} )$$

may be associated with a positive label (l) or a negative label (l) with respect to the query (q). When the distance metric

$$( {d}_{l}^{a} )$$

is designated as

$${d}_{p}^{a}$$

(the attribute-based distance between query and positive) and when associated with a negative label it is designated as

$${d}_{n}^{a}$$

(the attribute-based distance between query and negative).

After all distance metrics have been determined for positive and negative label embeddings, the example loss function circuitry 206 determines a dynamic margin (m_{d}) in a manner consistent with example Equation 9.

$${m}_{d} = \frac{\vert {d}_{p}^{a} - {d}_{n}^{a} \vert}{{D}^{a}} . \qquad Equation 9$$

In the illustrated example of Equation 9, D_{α} is the maximum attribute distance possible across products to normalize any subtraction to lie within a range of zero to one. The example loss function circuitry 206 applies the dynamic slope (m_{d}) to the triplet loss function to calculate the triplet loss (L_{T}), such as the example triplet loss function of example Equation 1. The example model trainer circuitry 104 uses the triplet loss values to train one or more models in a manner with improved accuracy because, in part, the triplet loss values (L_{T}) reflect a relative magnitude of similarity between positive labels and negative labels.

In some examples, positive labels and negative labels are associated with similarity values that result in uncertain settings when projected in close-by regions of an embedding space. Examples disclosed herein account for inaccuracies of dynamic margin estimation by clipping the dynamic margin determinations in view of maximum possible margin values and minimum possible margin values. For instance, product attributes may exhibit a degree of error, which may result in dynamic margin errors and/or dynamic margin estimations that have the potential to be more accurate when attribute errors are considered. In some examples, when determining dynamic margin values based on model similarities, such model similarity values may be inaccurate, which thwart training accuracy efforts. As such, examples disclosed herein clip dynamic margin estimations to narrow a range of possible margin values to reduce estimation errors.

Example Equation 10 represents a clipping function clip (x).

$$clip ( x ) = \{ \begin{matrix}x , if {γ}_{min} \leq x \leq {γ}_{max} \\ {γ}_{min} , if x < {γ}_{min} \\ {γ}_{max} , if x > {γ}_{max}\end{matrix} . \qquad Equation 10$$

In the illustrated example of Equation 10, a minimum clipping threshold (γₘᵢₙ) and a maximum clipping threshold (γₘₐₓ) are established (e.g., empirically determined). Based on the clipping thresholds, examples disclosed herein determine a triplet loss in a manner consistent with example Equation 11.

$${L}_{T}^{c d} = \{ \begin{matrix}0 , if {C}_{p} , {Δ}_{q}^{p − n} \geq {γ}_{min} \\ {Δ}_{q}^{p − n} + {γ}_{min} , if {C}_{p} , {Δ}_{q}^{p − n} < {γ}_{min} \\ {Δ}_{q}^{n − p} + clip ( Δ {s}_{q}^{n − p} ) , if {C}_{n}\end{matrix} . \qquad Equation 11$$

In the illustrated example of Equation 11, Cₚ represents circumstances where the cosine similarity between a query (e.g., an anchor) and a positive label are numerically greater than the cosine similarity between the query and a negative label (Cₚ: s_{qp}>s_{qn}). Conversely, Cₙ represents circumstances where the cosine similarity between a query and a positive label are numerically less than the cosine similarity between the query and a negative label (Cₙ: s_{qn}s_{qp}). Stated differently, Cₚ and Cₙ represent inequality conditions of the dynamic margin. Additionally, the illustrated example of Equation 11 shows that the addition of the dynamic margin removes fixed margin constraints and enables a model to learn from any observation that satisfies condition Cₙ, where negatives are closer to the query than positives. Further, the illustrated example of Equation 11 introduces a new learning region where the gradient direction is inverted (e.g., negatives are pulled closer to the anchor while positives are pushed apart until sₐₚ>sₐₙ) in a manner consistent with example Relationship 12.

$${C}_{p} , {Δ}_{q}^{p - n} < {γ}_{min} . \qquad Relationship 12$$

The example region where positives and negatives are nearly equally distant to the query covers circumstances with relatively high uncertainty such as fine-grain differences or missing labels, which represent challenges in extreme multi-label setup(s). In some cases, gradients are removed from the dynamic margin values, which has an effect on how the computational graph handles gradient computation (e.g., via Pytorch). Generally, the computational graph may be implemented as a directed acyclic graph (DAG) that represents a sequence of operations performed on tensors. The computational graph is used to compute gradients during the backpropagation process, and keeps track of the operations and dependencies between the tensors during optimization efforts.

Examples disclosed herein revert the learning process in this relatively small margin to prevent a network from taking risks and separating positives, while pulling negatives relatively closer to the query. In some circumstances (e.g., referred to as “easy cases” where sₐₚ>sₐₙ and

$${Δ}_{a}^{p - n} > {y}_{min} ) ,$$

positives are closer to the anchor than negatives with reasonable and/or otherwise distinguishable separation. In such easy case circumstances, there is no need to back-propagate. In some circumstances (e.g., referred to as “hard cases” where sₐₚ≤sₐₙ), the same gradients (e.g., norm and direction) are maintained as in triplet loss circumstances where negatives are closer to the anchor than positives. In some circumstances where there may be ambiguity and/or missing labels (e.g., where sₐₚ>sₐₙ, and

$${Δ}_{a}^{p - n} < {γ}_{min} ) ,$$

the dynamic margin relaxes the triplet loss by allowing positives and negatives to operate in a region where both representations are closer to each other. As such, the direction of partial derivatives is inverted, which allows inversion of the order of positives and negatives with respect to the anchor that corresponds to uncertain observations.

While an example manner of implementing the model trainer circuitry 104 of FIG. 1 is illustrated in FIG. 2A, one or more of the elements, processes, and/or devices illustrated in FIG. 2A may be combined, divided, re-arranged, omitted, eliminated, and/or implemented in any other way. Further, the example data acquisition circuitry 202, the example similarity circuitry 204, the example loss function circuitry 206, and/or, more generally, the example model trainer circuitry 104 of FIG. 2A, may be implemented by hardware alone or by hardware in combination with software and/or firmware. Thus, for example, any of the example data acquisition circuitry 202, the example similarity circuitry 204, the example loss function circuitry 206, and/or, more generally, the example model trainer circuitry 104 of FIG. 2A, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example model trainer circuitry 104 of FIG. 2A may include one or more elements, processes, and/or devices in addition to, or instead of, those illustrated in FIG. 2A, and/or may include more than one of any or all of the illustrated elements, processes and devices.

Flowchart(s) representative of example machine-readable instructions, which may be executed by programmable circuitry to implement and/or instantiate the model trainer circuitry 104 of FIG. 2A and/or representative of example operations which may be performed by programmable circuitry to implement and/or instantiate the model trainer circuitry 104 of FIG. 2A, are shown in FIGS. 3-5. The machine-readable instructions may be one or more executable programs or portion(s) of one or more executable programs for execution by programmable circuitry such as the programmable circuitry 612 shown in the example processor platform 600 discussed below in connection with FIG. 6 and/or may be one or more function(s) or portion(s) of functions to be performed by the example programmable circuitry (e.g., an FPGA) discussed below in connection with FIGS. 7 and/or 8. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 3-5, many other methods of implementing the example model trainer circuitry 104 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 3-5 may be implemented using executable instructions (e.g., computer readable and/or machine-readable instructions) stored on one or more non-transitory computer readable and/or machine-readable media. As used herein, the terms non-transitory computer readable medium, non-transitory computer readable storage medium, non-transitory machine-readable medium, and/or non-transitory machine-readable storage medium are expressly defined to include any type of computer readable storage device and/or storage disk and to exclude propagating signals and to exclude transmission media. Examples of such non-transitory computer readable medium, non-transitory computer readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine-readable instructions, etc., and/or manufactured to execute computer-readable instructions, machine-readable instructions, etc.

FIG. 3 is a flowchart representative of example machine-readable instructions and/or example operations 300 that may be executed, instantiated, and/or performed by programmable circuitry to train a model with a dynamic margin. The example machine-readable instructions and/or the example operations 300 of FIG. 3 begin at block 302, at which the example data acquisition circuitry 202 acquires a training data set of query embeddings (h_{q}), positive label embeddings (hₚ), and negative label embeddings (hₙ). The example similarity circuitry 204 determines similarity values for pairs of the query embeddings (h_{q}) and the positive label embeddings (hₚ) (block 304), referred to as a positive similarity (s_{qp}) or a positive cosine similarity value. The example similarity circuitry 204 also determines similarity values for pairs of the query embeddings (h_{q}) and the negative label embeddings (hₙ) (block 304), referred to as a negative similarity (s_{qn}) or a negative cosine similarity value. In some examples, the similarity values are determined via a cosine similarity technique, but examples disclosed herein are not limited thereto.

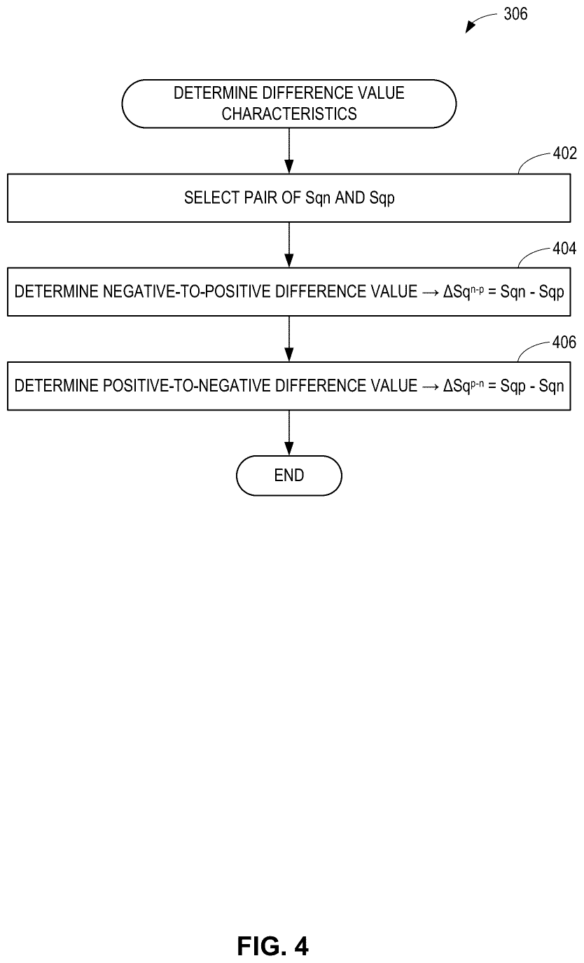

The example similarity circuitry 204 determines difference value characteristics (block 306). In particular, the illustrated example of FIG. 4 described additional detail corresponding to block 306. In the illustrated example of FIG. 4, the similarity circuitry 204 selects pairs of the negative similarity value (s_{qn}) and the positive similarity value (s_{qp}) (block 402). The similarity circuitry 204 determines, for each pair, a negative-to-positive difference value

$$( Δ {s}_{q}^{n - p} )$$

In a manner consistent with example Equation 3 (block 404). Additionally, the similarity circuitry 204 determines, for each pair, a positive-to-negative difference value

$$( Δ {s}_{q}^{p - n} )$$

in a manner consistent with example Equation 4 (block 406). Control then returns to block 308 of FIG. 3.

Returning to the illustrated example of FIG. 3, the similarity circuitry 204 determines whether the positive-to-negative difference value

$$( Δ {s}_{q}^{p - n} )$$

is less than or equal to zero (block 308). If not, then examples disclosed herein avoid further computational efforts to determine a loss function value and set the loss to zero (block 310). Stated differently, examples disclosed herein permit a degree of computational savings depending on a magnitude and sign of the positive-to-negative difference value. On the other hand, in the event the positive-to-negative difference value

$$( Δ {s}_{q}^{p - n} )$$

is less than or equal to zero (block 308), the loss function circuitry 206 establishes, determines and/or otherwise calculates a loss function value margin based on the negative-to-positive difference value

$$( Δ {s}_{q}^{n - p} )$$

(block 312). Additionally, the loss function circuitry 206 determines the loss function value in a manner consistent with example Equation 6.

The model trainer circuitry 104 determines if one or more pairs of query embeddings (h_{q}) and label embeddings (hₗ) have yet to be analyzed (block 314). If so, control of the example program 300 of FIG. 3 returns to block 306. On the other hand, the model trainer circuitry 104 determines whether training should continue in connection with a new training data set (block 316) and, if so, control returns to block 302, otherwise the example program 300 of FIG. 3 ends.

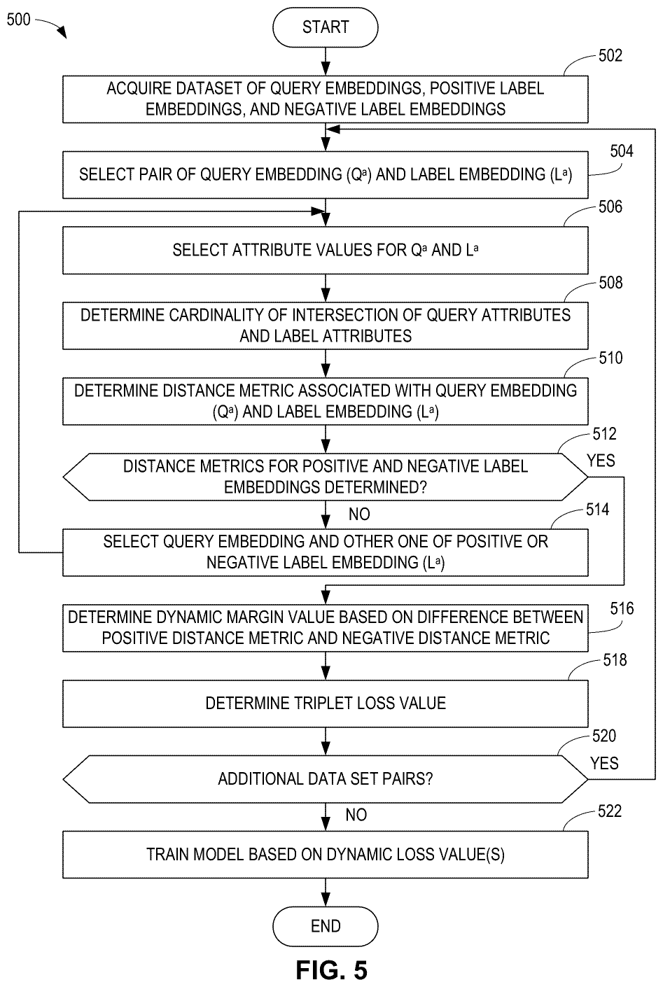

FIG. 5 is a flowchart representative of example machine-readable instructions and/or example operations 500 that may be executed, instantiated, and/or performed by example programmable circuitry to train a model with a dynamic margin influenced by object attributes. The example machine-readable instructions and/or the example operations 500 of FIG. 5 begin at block 502, at which the example data acquisition circuitry 202 acquires a data set of query embeddings, positive label embeddings, and negative label embeddings for purposes of training a model. The model trainer circuitry 104 selects a pair of embeddings having a query embedding with query attribute values (Q^{α}) and a label embedding with label attribute values (L^{α}) (block 504). Because each label embedding and query embedding can have any number of particular attributes, the model trainer circuitry 104 selects a subset of attributes for analysis (block 506). The example similarity circuitry 204 determines a cardinality of intersecting ones of the query attribute values (Q^{α}) and label attribute values (L^{α}) in a manner consistent with example Equation 7 (block 508). The example similarity circuitry 204 determines a distance metric

$$( {d}_{l}^{a} )$$

for the pair in a manner consistent with example Equation 8 (block 510).

The similarity circuitry 204 determines whether all distance metrics corresponding to positive and negative label embeddings have been determined and/or otherwise calculated (block 512). If not, then the model trainer circuitry 104 selects the previously selected query embedding and the other one of the positive or the negative label embedding (block 514). Control then returns to block 506. However, if all distance metrics have been determined (block 512), then the loss function circuitry 206 determines a dynamic margin (m_{d}) in a manner consistent with example Equation 9 (block 516), and then determines the triplet loss (L_{T}) in a manner consistent with example Equation 1 (block 518). The model trainer circuitry 104 determines if additional data set pairs are to be analyzed (block 520) and, if so, control returns to block 504. Otherwise, the model trainer circuitry 104 uses the calculated loss values to train one or more models (block 522).

FIG. 6 is a block diagram of an example programmable circuitry platform 600 structured to execute and/or instantiate the example machine-readable instructions and/or the example operations of FIGS. 3-5 to implement the model trainer circuitry 104 of FIG. 2A. The programmable circuitry platform 600 can be, for example, a server, a personal computer, a workstation, a self-learning machine (e.g., a neural network), a mobile device (e.g., a cell phone, a smart phone, a tablet such as an iPad™), an Internet appliance, a gaming console, a set top box, a headset (e.g., an augmented reality (AR) headset, a virtual reality (VR) headset, etc.) or other wearable device, or any other type of computing and/or electronic device.

The programmable circuitry platform 600 of the illustrated example includes programmable circuitry 612. The programmable circuitry 612 of the illustrated example is hardware. For example, the programmable circuitry 612 can be implemented by one or more integrated circuits, logic circuits, FPGAs, microprocessors, CPUs, GPUs, DSPs, and/or microcontrollers from any desired family or manufacturer. The programmable circuitry 612 may be implemented by one or more semiconductor based (e.g., silicon based) devices. In this example, the programmable circuitry 612 implements the example data acquisition circuitry 202, the example similarity circuitry 204, the example loss function circuitry 206, and/or, more generally, the example model trainer circuitry 104 of FIG. 2A.

The programmable circuitry 612 of the illustrated example includes a local memory 613 (e.g., a cache, registers, etc.). The programmable circuitry 612 of the illustrated example is in communication with main memory 614, 616, which includes a volatile memory 614 and a non-volatile memory 616, by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. Access to the main memory 614, 616 of the illustrated example is controlled by a memory controller 617. In some examples, the memory controller 617 may be implemented by one or more integrated circuits, logic circuits, microcontrollers from any desired family or manufacturer, or any other type of circuitry to manage the flow of data going to and from the main memory 614, 616.

The programmable circuitry platform 600 of the illustrated example also includes interface circuitry 620. The interface circuitry 620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 622 are connected to the interface circuitry 620. The input device(s) 622 permit(s) a user (e.g., a human user, a machine user, etc.) to enter data and/or commands into the programmable circuitry 612. The input device(s) 622 can be implemented by, for example, an audio sensor, a microphone, a camera (still or video), a keyboard, a button, a mouse, a touchscreen, a trackpad, a trackball, an isopoint device, and/or a voice recognition system.

One or more output devices 624 are also connected to the interface circuitry 620 of the illustrated example. The output device(s) 624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 620 of the illustrated example, thus, typically includes a graphics driver card, a graphics driver chip, and/or graphics processor circuitry such as a GPU.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 600 of the illustrated example also includes one or more mass storage discs or devices 628 to store firmware, software, and/or data. Examples of such mass storage discs or devices 628 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 632, which may be implemented by the machine-readable instructions of FIGS. 3-5, may be stored in the mass storage device 628, in the volatile memory 614, in the non-volatile memory 616, and/or on at least one non-transitory computer readable storage medium such as a CD or DVD which may be removable.

FIG. 7 is a block diagram of an example implementation of the programmable circuitry 612 of FIG. 6. In this example, the programmable circuitry 612 of FIG. 6 is implemented by a microprocessor 700. For example, the microprocessor 700 may be a general-purpose microprocessor (e.g., general-purpose microprocessor circuitry). The microprocessor 700 executes some or all of the machine-readable instructions of the flowcharts of FIGS. 3-5 to effectively instantiate the circuitry of FIG. 2A as logic circuits to perform operations corresponding to those machine-readable instructions. In some such examples, the circuitry of FIG. 2A is instantiated by the hardware circuits of the microprocessor 700 in combination with the machine-readable instructions. For example, the microprocessor 700 may be implemented by multi-core hardware circuitry such as a CPU, a DSP, a GPU, an XPU, etc. Although it may include any number of example cores 702 (e.g., 1 core), the microprocessor 700 of this example is a multi-core semiconductor device including N cores. The cores 702 of the microprocessor 700 may operate independently or may cooperate to execute machine-readable instructions. For example, machine code corresponding to a firmware program, an embedded software program, or a software program may be executed by one of the cores 702 or may be executed by multiple ones of the cores 702 at the same or different times. In some examples, the machine code corresponding to the firmware program, the embedded software program, or the software program is split into threads and executed in parallel by two or more of the cores 702. The software program may correspond to a portion or all of the machine-readable instructions and/or operations represented by the flowcharts of FIGS. 3-5.

The cores 702 may communicate by a first example bus 704. In some examples, the first bus 704 may be implemented by a communication bus to effectuate communication associated with one(s) of the cores 702. For example, the first bus 704 may be implemented by at least one of an Inter-Integrated Circuit (I2C) bus, a Serial Peripheral Interface (SPI) bus, a PCI bus, or a PCIe bus. Additionally or alternatively, the first bus 704 may be implemented by any other type of computing or electrical bus. The cores 702 may obtain data, instructions, and/or signals from one or more external devices by example interface circuitry 706. The cores 702 may output data, instructions, and/or signals to the one or more external devices by the interface circuitry 706. Although the cores 702 of this example include example local memory 720 (e.g., Level 1 (L1) cache that may be split into an L1 data cache and an L1 instruction cache), the microprocessor 700 also includes example shared memory 710 that may be shared by the cores (e.g., Level 2 (L2 cache)) for high-speed access to data and/or instructions. Data and/or instructions may be transferred (e.g., shared) by writing to and/or reading from the shared memory 710. The local memory 720 of each of the cores 702 and the shared memory 710 may be part of a hierarchy of storage devices including multiple levels of cache memory and the main memory (e.g., the main memory 614, 616 of FIG. 6). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 702 may be referred to as a CPU, DSP, GPU, etc., or any other type of hardware circuitry. Each core 702 includes control unit circuitry 714, arithmetic and logic (AL) circuitry (sometimes referred to as an ALU) 716, a plurality of registers 718, the local memory 720, and a second example bus 722. Other structures may be present. For example, each core 702 may include vector unit circuitry, single instruction multiple data (SIMD) unit circuitry, load/store unit (LSU) circuitry, branch/jump unit circuitry, floating-point unit (FPU) circuitry, etc. The control unit circuitry 714 includes semiconductor-based circuits structured to control (e.g., coordinate) data movement within the corresponding core 702. The AL circuitry 716 includes semiconductor-based circuits structured to perform one or more mathematic and/or logic operations on the data within the corresponding core 702. The AL circuitry 716 of some examples performs integer based operations. In other examples, the AL circuitry 716 also performs floating-point operations. In yet other examples, the AL circuitry 716 may include first AL circuitry that performs integer-based operations and second AL circuitry that performs floating-point operations. In some examples, the AL circuitry 716 may be referred to as an Arithmetic Logic Unit (ALU).

The registers 718 are semiconductor-based structures to store data and/or instructions such as results of one or more of the operations performed by the AL circuitry 716 of the corresponding core 702. For example, the registers 718 may include vector register(s), SIMD register(s), general-purpose register(s), flag register(s), segment register(s), machine-specific register(s), instruction pointer register(s), control register(s), debug register(s), memory management register(s), machine check register(s), etc. The registers 718 may be arranged in a bank as shown in FIG. 7. Alternatively, the registers 718 may be organized in any other arrangement, format, or structure, such as by being distributed throughout the core 702 to shorten access time. The second bus 722 may be implemented by at least one of an I2C bus, a SPI bus, a PCI bus, or a PCIe bus.

Each core 702 and/or, more generally, the microprocessor 700 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 700 is a semiconductor device fabricated to include many transistors interconnected to implement the structures described above in one or more integrated circuits (ICs) contained in one or more packages.

The microprocessor 700 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 700, in the same chip package as the microprocessor 700 and/or in one or more separate packages from the microprocessor 700.

FIG. 8 is a block diagram of another example implementation of the programmable circuitry 612 of FIG. 6. In this example, the programmable circuitry 612 is implemented by FPGA circuitry 800. For example, the FPGA circuitry 800 may be implemented by an FPGA. The FPGA circuitry 800 can be used, for example, to perform operations that could otherwise be performed by the example microprocessor 700 of FIG. 7 executing corresponding machine-readable instructions. However, once configured, the FPGA circuitry 800 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 700 of FIG. 7 described above (which is a general purpose device that may be programmed to execute some or all of the machine-readable instructions represented by the flowchart(s) of FIGS. 3-5 but whose interconnections and logic circuitry are fixed once fabricated), the FPGA circuitry 800 of the example of FIG. 8 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 3-5. In particular, the FPGA circuitry 800 may be thought of as an array of logic gates, interconnections, and switches. The switches can be programmed to change how the logic gates are interconnected by the interconnections, effectively forming one or more dedicated logic circuits (unless and until the FPGA circuitry 800 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 3-5. As such, the FPGA circuitry 800 may be configured and/or structured to effectively instantiate some or all of the operations/functions corresponding to the machine-readable instructions of the flowchart(s) of FIGS. 3-5 as dedicated logic circuits to perform the operations/functions corresponding to those software instructions in a dedicated manner analogous to an ASIC. Therefore, the FPGA circuitry 800 may perform the operations/functions corresponding to the some or all of the machine-readable instructions of FIGS. 3-5 faster than the general-purpose microprocessor can execute the same.

In the example of FIG. 8, the FPGA circuitry 800 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL: the code/program may be translated into a low-level language as needed; and the code/program (e.g., the code/program in the low-level language) may be converted (e.g., by a compiler, a software application, etc.) into the binary file. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

The FPGA circuitry 800 of FIG. 8, includes example input/output (I/O) circuitry 802 to obtain and/or output data to/from example configuration circuitry 804 and/or external hardware 806. For example, the configuration circuitry 804 may be implemented by interface circuitry that may obtain a binary file, which may be implemented by a bit stream, data, and/or machine-readable instructions, to configure the FPGA circuitry 800, or portion(s) thereof. In some such examples, the configuration circuitry 804 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 806 may be implemented by external hardware circuitry. For example, the external hardware 806 may be implemented by the microprocessor 700 of FIG. 7.

The FPGA circuitry 800 also includes an array of example logic gate circuitry 808, a plurality of example configurable interconnections 810, and example storage circuitry 812. The logic gate circuitry 808 and the configurable interconnections 810 are configurable to instantiate one or more operations/functions that may correspond to at least some of the machine-readable instructions of FIGS. 3-5 and/or other desired operations. The logic gate circuitry 808 shown in FIG. 8 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 808 to enable configuration of the electrical structures and/or the logic gates to form circuits to perform desired operations/functions. The logic gate circuitry 808 may include other electrical structures such as look-up tables (LUTs), registers (e.g., flip-flops or latches), multiplexers, etc.

The configurable interconnections 810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 808 to program desired logic circuits.

The storage circuitry 812 of the illustrated example is structured to store result(s) of the one or more of the operations performed by corresponding logic gates. The storage circuitry 812 may be implemented by registers or the like. In the illustrated example, the storage circuitry 812 is distributed amongst the logic gate circuitry 808 to facilitate access and increase execution speed.

The example FPGA circuitry 800 of FIG. 8 also includes example dedicated operations circuitry 814. In this example, the dedicated operations circuitry 814 includes special purpose circuitry 816 that may be invoked to implement commonly used functions to avoid the need to program those functions in the field. Examples of such special purpose circuitry 816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 800 may also include example general purpose programmable circuitry 818 such as an example CPU 820 and/or an example DSP 822. Other general purpose programmable circuitry 818 may additionally or alternatively be present such as a GPU, an XPU, etc., that can be programmed to perform other operations.

Although FIGS. 7 and 8 illustrate two example implementations of the programmable circuitry 612 of FIG. 6, many other approaches are contemplated. For example, FPGA circuitry may include an on-board CPU, such as one or more of the example CPU 820 of FIG. 7. Therefore, the programmable circuitry 612 of FIG. 6 may additionally be implemented by combining at least the example microprocessor 700 of FIG. 7 and the example FPGA circuitry 800 of FIG. 8. In some such hybrid examples, one or more cores 702 of FIG. 7 may execute a first portion of the machine-readable instructions represented by the flowchart(s) of FIGS. 3-5 to perform first operation(s)/function(s), the FPGA circuitry 800 of FIG. 8 may be configured and/or structured to perform second operation(s)/function(s) corresponding to a second portion of the machine-readable instructions represented by the flowcharts of FIGS. 3-5, and/or an ASIC may be configured and/or structured to perform third operation(s)/function(s) corresponding to a third portion of the machine-readable instructions represented by the flowcharts of FIGS. 3-5.

It should be understood that some or all of the circuitry of FIG. 2A may, thus, be instantiated at the same or different times. For example, same and/or different portion(s) of the microprocessor 700 of FIG. 7 may be programmed to execute portion(s) of machine-readable instructions at the same and/or different times. In some examples, same and/or different portion(s) of the FPGA circuitry 800 of FIG. 8 may be configured and/or structured to perform operations/functions corresponding to portion(s) of machine-readable instructions at the same and/or different times.

In some examples, some or all of the circuitry of FIG. 2A may be instantiated, for example, in one or more threads executing concurrently and/or in series. For example, the microprocessor 700 of FIG. 7 may execute machine-readable instructions in one or more threads executing concurrently and/or in series. In some examples, the FPGA circuitry 800 of FIG. 8 may be configured and/or structured to carry out operations/functions concurrently and/or in series. Moreover, in some examples, some or all of the circuitry of FIG. 2A may be implemented within one or more virtual machines and/or containers executing on the microprocessor 700 of FIG. 7.

In some examples, the programmable circuitry 612 of FIG. 6 may be in one or more packages. For example, the microprocessor 700 of FIG. 7 and/or the FPGA circuitry 800 of FIG. 8 may be in one or more packages. In some examples, an XPU may be implemented by the programmable circuitry 612 of FIG. 6, which may be in one or more packages. For example, the XPU may include a CPU (e.g., the microprocessor 700 of FIG. 7, the CPU 820 of FIG. 8, etc.) in one package, a DSP (e.g., the DSP 822 of FIG. 8) in another package, a GPU in yet another package, and an FPGA (e.g., the FPGA circuitry 800 of FIG. 8) in still yet another package.

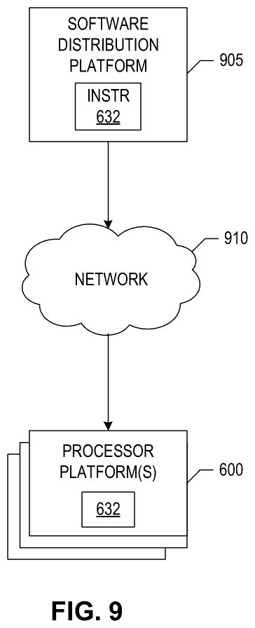

A block diagram illustrating an example software distribution platform 905 to distribute software such as the example machine-readable instructions 632 of FIG. 6 to other hardware devices (e.g., hardware devices owned and/or operated by third parties from the owner and/or operator of the software distribution platform) is illustrated in FIG. 9. The example software distribution platform 905 may be implemented by any computer server, data facility, cloud service, etc., capable of storing and transmitting software to other computing devices. The third parties may be customers of the entity owning and/or operating the software distribution platform 905. For example, the entity that owns and/or operates the software distribution platform 905 may be a developer, a seller, and/or a licensor of software such as the example machine-readable instructions 632 of FIG. 6. The third parties may be consumers, users, retailers, OEMs, etc., who purchase and/or license the software for use and/or re-sale and/or sub-licensing. In the illustrated example, the software distribution platform 905 includes one or more servers and one or more storage devices. The storage devices store the machine-readable instructions 632, which may correspond to the example machine-readable instructions of FIGS. 3-5, as described above. The one or more servers of the example software distribution platform 905 are in communication with an example network 910, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine-readable instructions 632 from the software distribution platform 905. For example, the software, which may correspond to the example machine-readable instructions of FIGS. 3-5, may be downloaded to the example programmable circuitry platform 600, which is to execute the machine-readable instructions 632 to implement the model trainer circuitry 104. In some examples, one or more servers of the software distribution platform 905 periodically offer, transmit, and/or force updates to the software (e.g., the example machine-readable instructions 632 of FIG. 6) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that train models using a dynamic margin. Unlike traditional techniques to train models with a loss function that employ one or more static margins, examples disclosed herein enable an influence of varying degrees of data hardness to permit greater loss value granularity. Such granularity is lost in view of known techniques to calculate loss values in connection with positive labels and negative labels, in which any established static margin does not reflect relative gaps between similarities between the positive and negative labels. Accordingly, examples disclosed herein improve model inference accuracy by training such models with more accurate loss calculations. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to train a machine learning model with a dynamic margin are disclosed herein. Further examples and combinations thereof include the following:

Example 1 includes an apparatus comprising interface circuitry, machine-readable instructions, and at least one processor circuit to be programmed by the machine-readable instructions to determine a positive label similarity value and a negative label similarity value, the positive and negative similarity values based on a query embedding, determine a negative-to-positive difference value associated with the positive label similarity value and the negative label similarity value, determine a positive-to-negative difference value associated with the positive label similarity value and the negative label similarity value, and cause training of a label classifier with a loss function having a dynamic margin when the positive-to-negative difference value satisfies a threshold.

Example 2 includes the apparatus as defined in example 1, wherein one or more of the at least one processor circuit is to determine the dynamic margin as the negative-to-positive difference value, the negative-to-positive difference value based on a difference between the negative label similarity value and the positive label similarity value.

Example 3 includes the apparatus as defined in example 2, wherein one or more of the at least one processor circuit is to determine the positive-to-negative difference value satisfies the threshold when the threshold is less than zero.

Example 4 includes the apparatus as defined in example 1, wherein one or more of the at least one processor circuit is to cause training of the label classifier with the loss function having a value of zero when the positive-to-negative difference value does not satisfy the threshold.

Example 5 includes the apparatus as defined in example 1, wherein one or more of the at least one processor circuit is to train the label classifier using a triplet loss function.

Example 6 includes the apparatus as defined in example 1, wherein one or more of the at least one processor circuit is to determine the positive label similarity value based on a cosine similarity of (a) a positive label embedding and (b) the query embedding.

Example 7 includes the apparatus as defined in example 1, wherein one or more of the at least one processor circuit is to determine the negative label similarity value based on a cosine similarity of (a) the negative label embedding and (b) the query embedding.

Example 8 includes At least one non-transitory machine-readable medium comprising machine-readable instructions to cause at least one processor circuit to at least determine a positive label similarity value and a negative label similarity value, the positive and negative similarity values based on a query embedding, determine a negative-to-positive difference value and a positive-to-negative difference value associated with the positive label similarity value and the negative label similarity value, determine a positive-to-negative difference value associated with the positive label similarity value and the negative label similarity value, and train a label classifier with a loss function having a dynamic margin when the positive-to-negative difference value satisfies a threshold.

Example 9 includes the at least one non-transitory machine-readable medium as defined in example 8, wherein the machine-readable instructions are to cause one or more of the at least one processor circuit to determine the dynamic margin as the negative-to-positive difference value, the negative-to-positive difference value based on a difference between the negative label similarity value and the positive label similarity value.

Example 10 includes the at least one non-transitory machine-readable medium as defined in example 9, wherein the machine-readable instructions are to cause one or more of the at least one processor circuit to determine the positive-to-negative difference value satisfies the threshold when the threshold is less than zero.

Example 11 includes the at least one non-transitory machine-readable medium as defined in example 8, wherein the machine-readable instructions are to cause one or more of the at least one processor circuit to train the label classifier with the loss function having a value of zero when the positive-to-negative difference value does not satisfy the threshold.

Example 12 includes the at least one non-transitory machine-readable medium as defined in example 8, wherein the machine-readable instructions are to cause one or more of the at least one processor circuit to train the label classifier using a triplet loss function.

Example 13 includes the at least one non-transitory machine-readable medium as defined in example 8, wherein the machine-readable instructions are to cause one or more of the at least one processor circuit to determine the positive label similarity value based on a cosine similarity of (a) a positive label embedding and (b) the query embedding.

Example 14 includes the at least one non-transitory machine-readable medium as defined in example 8, wherein the machine-readable instructions are to cause one or more of the at least one processor circuit to determine the negative label similarity value based on a cosine similarity of (a) the negative label embedding and (b) the query embedding.

Example 15 includes a system comprising means for similarity determination to determine a positive label similarity value and a negative label similarity value, the positive and negative similarity values based on a query embedding, determine a negative-to-positive difference value associated with the positive label similarity value and the negative label similarity value, and determine a positive-to-negative difference value associated with the positive label similarity value and the negative label similarity value, and means for training a model to cause training of a label classifier with a loss function having a dynamic margin when the positive-to-negative difference value satisfies a threshold.

Example 16 includes the system as defined in example 15, wherein the means for similarity determination is to determine the dynamic margin as the negative-to-positive difference value, the negative-to-positive difference value based on a difference between the negative label similarity value and the positive label similarity value.

Example 17 includes the system as defined in example 16, wherein the means for similarity determination is to determine the positive-to-negative difference value satisfies the threshold when the threshold is less than zero.

Example 18 includes the system as defined in example 15, wherein the means for training a model is to cause training of the label classifier with the loss function having a value of zero when the positive-to-negative difference value does not satisfy the threshold.

Example 19 includes the system as defined in example 15, wherein the means for training a model is to train the label classifier using a triplet loss function.

Example 20 includes the system as defined in example 15, wherein the means for similarity determination is to determine the positive label similarity value based on a cosine similarity of (a) a positive label embedding and (b) the query embedding.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
machine-readable instructions; and
at least one processor circuit to be programmed by the machine-readable instructions to:
determine a positive label similarity value and a negative label similarity value, the positive and negative similarity values based on a query embedding;
determine a negative-to-positive difference value associated with the positive label similarity value and the negative label similarity value;
determine a positive-to-negative difference value associated with the positive label similarity value and the negative label similarity value; and
cause training of a label classifier with a loss function having a dynamic margin when the positive-to-negative difference value satisfies a threshold.

2. The apparatus as defined in claim 1, wherein one or more of the at least one processor circuit is to determine the dynamic margin as the negative-to-positive difference value, the negative-to-positive difference value based on a difference between the negative label similarity value and the positive label similarity value.

3. The apparatus as defined in claim 2, wherein one or more of the at least one processor circuit is to determine the positive-to-negative difference value satisfies the threshold when the threshold is less than zero.

4. The apparatus as defined in claim 1, wherein one or more of the at least one processor circuit is to cause training of the label classifier with the loss function having a value of zero when the positive-to-negative difference value does not satisfy the threshold.

5. The apparatus as defined in claim 1, wherein one or more of the at least one processor circuit is to train the label classifier using a triplet loss function.

6. The apparatus as defined in claim 1, wherein one or more of the at least one processor circuit is to determine the positive label similarity value based on a cosine similarity of (a) a positive label embedding and (b) the query embedding.

7. The apparatus as defined in claim 1, wherein one or more of the at least one processor circuit is to determine the negative label similarity value based on a cosine similarity of (a) the negative label embedding and (b) the query embedding.

8. At least one non-transitory machine-readable medium comprising machine-readable instructions to cause at least one processor circuit to at least:
determine a positive label similarity value and a negative label similarity value, the positive and negative similarity values based on a query embedding;
determine a negative-to-positive difference value and a positive-to-negative difference value associated with the positive label similarity value and the negative label similarity value;
determine a positive-to-negative difference value associated with the positive label similarity value and the negative label similarity value; and
train a label classifier with a loss function having a dynamic margin when the positive-to-negative difference value satisfies a threshold.

9. The at least one non-transitory machine-readable medium as defined in claim 8, wherein the machine-readable instructions are to cause one or more of the at least one processor circuit to determine the dynamic margin as the negative-to-positive difference value, the negative-to-positive difference value based on a difference between the negative label similarity value and the positive label similarity value.

10. The at least one non-transitory machine-readable medium as defined in claim 9, wherein the machine-readable instructions are to cause one or more of the at least one processor circuit to determine the positive-to-negative difference value satisfies the threshold when the threshold is less than zero.

11. The at least one non-transitory machine-readable medium as defined in claim 8, wherein the machine-readable instructions are to cause one or more of the at least one processor circuit to train the label classifier with the loss function having a value of zero when the positive-to-negative difference value does not satisfy the threshold.

12. The at least one non-transitory machine-readable medium as defined in claim 8, wherein the machine-readable instructions are to cause one or more of the at least one processor circuit to train the label classifier using a triplet loss function.

13. The at least one non-transitory machine-readable medium as defined in claim 8, wherein the machine-readable instructions are to cause one or more of the at least one processor circuit to determine the positive label similarity value based on a cosine similarity of (a) a positive label embedding and (b) the query embedding.

14. The at least one non-transitory machine-readable medium as defined in claim 8, wherein the machine-readable instructions are to cause one or more of the at least one processor circuit to determine the negative label similarity value based on a cosine similarity of (a) the negative label embedding and (b) the query embedding.

15. A system comprising:
means for similarity determination to:
determine a positive label similarity value and a negative label similarity value, the positive and negative similarity values based on a query embedding;
determine a negative-to-positive difference value associated with the positive label similarity value and the negative label similarity value; and
determine a positive-to-negative difference value associated with the positive label similarity value and the negative label similarity value; and
means for training a model to cause training of a label classifier with a loss function having a dynamic margin when the positive-to-negative difference value satisfies a threshold.

16. The system as defined in claim 15, wherein the means for similarity determination is to determine the dynamic margin as the negative-to-positive difference value, the negative-to-positive difference value based on a difference between the negative label similarity value and the positive label similarity value.

17. The system as defined in claim 16, wherein the means for similarity determination is to determine the positive-to-negative difference value satisfies the threshold when the threshold is less than zero.

18. The system as defined in claim 15, wherein the means for training a model is to cause training of the label classifier with the loss function having a value of zero when the positive-to-negative difference value does not satisfy the threshold.

19. The system as defined in claim 15, wherein the means for training a model is to train the label classifier using a triplet loss function.

20. The system as defined in claim 15, wherein the means for similarity determination is to determine the positive label similarity value based on a cosine similarity of (a) a positive label embedding and (b) the query embedding.
